(19) United States
(12) Patent Application Publication
(10) Pub. No.: US 2025/0128342 A1
(43) Pub. Date: Apr. 24, 2025

(54) CORRUGATED TUBE JACKET STRIPPING TOOL

(71) Applicant: Pro-Flex, LLC, Hillsboro, IN (US)

(72) Inventor: Joseph N. Ismert, Stilwell, KS (US)

(73) Assignee: Pro-Flex, LLC, Hillsboro, IN (US)

(21) Appl. No.: 18/922,704

(22) Filed: Oct. 22, 2024

Related U.S. Application Data
(60) Provisional application No. 63/592,338, filed on Oct. 23, 2023.

(51) Int. Cl. B23D 21/10

(52) U.S. Cl. CPC B23D 21/10

(57) ABSTRACT

A tool for removing an outer jacketing material from a corrugated tubing. The tool includes a tubular housing with a first end having a bore extending therein for receiving the jacketed corrugated tubing and a second end with a tool connector. A blade is fixed through an opening within the housing near the first end. As the jacketed tube is pushed into the bore, the blade engages the jacketing material without scoring the corrugated tubing. Rotation of the tubular housing via the tool connector along with inboard movement of the tubing within the housing bore further engages the blade with the jacketing material. As the jacketed tubing is moved into the bore, the blade circumferentially removes the jacket from the tube. The blade is configured and positioned so as not to engage the corrugated metal tubing from which the jacket is to be removed.

### CROSS-REFERENCE TO RELATED APPLICATIONS

This application claims the benefit of U.S. Provisional Patent Application No. 63/592,338, filed Oct. 23, 2023, the disclosure of which is hereby incorporated herein in its entirety by reference.

### BACKGROUND

This invention relates generally to a novel tool for removing a jacketing material from corrugated tubing. More specifically, the tool will quickly and easily remove the flexible jacket material from corrugated metal tubing such as that used for conveyance of natural gas or propane gas without imparting any damage to the tubing.

Corrugated stainless steel tubing is generally used to convey natural gas or propane to appliances. The tubing generally comprises an inner corrugated stainless steel tube with the outer periphery fully encapsulated by a flexible jacket. The jacket can be made of plastic, rubber or similar materials that are flexible and tightly connect to the outer periphery of the tube itself. Removal of a portion of this jacket is necessary to attach a coupling directly to the stainless steel tube component for connectivity to appliances, or gas sources. It is essential that the removal of the jacket in no way imparts damage to the stainless steel tube itself. Because the tubing conveys flammable and explosive product, it is essential that the inner stainless steel tubing not be damaged during removal of the jacket portion. Minimal damage to the stainless steel tubing may result in rejection of the pipe installation for code compliance issues. Rotational wire stripping tools are a good solution to removal of outer layers of sheathing from wire. Several devices are known for removing outer sheathing from electrical wiring. It is often necessary to remove an outer sheathing, or multiple sheathings and insulating layers, from electrical wire for splicing or end connecting the wire to appliances. Generally, these tools are multifaceted with movable blades, a plurality of blades and adjustments for accommodation of different wire sizes. However, known tools lack the precision necessary for stripping the jacket from corrugated gas tubing. Plier-like stripping tools should not be used because it is essential to refrain from compressing or crimping corrugated tubing used for gas conveyance. Moreover, known tube stripping tools are prone to cutting, nicking or otherwise damaging interior components of the wire as the outer sheathing is removed. Very few tools exist to remove jacketing material from metal tubing or pipes. Workers often use a knife to score the covering material and then force it apart from the encapsulated tubing. This results in rough edges and damaged tubing which is unacceptable. Known tools require manual operation and are generally difficult to operate. They do not have blades that are replaceable and have limited usable life.

Accordingly, it is beneficial to provide an easy-to-use jacket stripping tool for removal of the outer layer of material from corrugated tubing. For control and precision of use, it is beneficial to provide tools which are size specific to the diameter of the tubing to be worked. Because multiple sizes of the tool are beneficial, it is preferred that the tool are inexpensive to manufacture. The tool should be easy to use, easy to maintain and have interchangeable wear components to ensure longevity.

### SUMMARY OF THE INVENTION

Accordingly, the instant invention is intended to overcome certain limitations that are present in known stripping devices. The invention is a tool for removing the outer coating or jacket from a corrugated tube. The tubing is generally used for delivery of compressed gas, natural gas or propane and an example would be ASTM A240 Type 304 321 stainless steel. The tubing is provided with a flexible jacket, sometimes referred to as a CSST jacket, which must be removed at the ends to accommodate direct fixation of connectors to the tubing. The connectors are used to fasten the tubing to gas sources and appliances. While the formation material of the tubing can vary, building code requires most gas tubing to be stainless steel. The jacket is electrically insulative and UV resistant polymer. Generally, the jacketing material must comply with ASTM E84 or similar codes. For most gas install applications, corrugated tubing has a diameter between ½ inch and 2 inches. Common sizes include ½, ¾, 1, 1 ¼, 1 ½ and 2 inches.

The tool has a tubular body with a central bore extending into the tubular body from an opening at a first end thereof. The opening and an initial bore section is sized to receive a jacketed tube of a specific diameter which passes a pre-determined distance into the bore. An opening within the wall of the tube near the first end is provided and a fixed blade is specifically oriented to engage the terminus of the jacketing material at the end of the tubing. Because the sizing of the bore within the tube is specific to the diameter of the tubing, the blade can be fixed in a position where it engages the jacketing material without engaging the underlying wall of the tubing. This prevents any scoring or other damage to the metal tubing. A blade is fixed through the opening so that the cutting edges of the blade project generally inward toward the tube. It is preferred that the blade be fastenable to the body of the tool with a screw or similar fastening device. Generally, it is preferred to remove approximately 1 to 1 ½ inches of the jacket from the stainless steel tube to provide a suitable connection or joint for attachment to a coupling end. Accordingly, the initial bore section, near the first end and into which the blade extends, is larger in diameter than a second bore section formed in the tool body inward of the initial bore section. The second bore section ends at a stop, past which the metal tubing from which the jacket has been removed cannot pass. This allows the jacketed, corrugated, stainless steel tube to be moved into the second bore section a limited distance and the configuration of the tool determines the length of the sheathing to be removed from the tubing. In use, the jacketed, corrugated, stainless steel tubing is inserted into the work end or first end of the tool and the tool is rotated around the tubing such that the blade engages and peels the jacketing material as the tubing moves inward the tube receiving bore.

In one embodiment of the invention, a blade mounting platform is formed at the outer periphery of the tool body adjacent the blade opening; this platform provides a surface for mounting the blade and is generally provided with a fastening component, such as a screw bore for the receipt of a fastening screw.

A tool connector may be provided at the second end of the tubular body for removably connecting to a rotational tool, such as a drill. Rotation of the tool connector rotates the entire tool and rotation of the tool about the stainless-steel tubing engages the blade with the jacket and separates the jacket from the tubing. In the preferred embodiment the tool connector comprises a shaft that is removable from the tubular body. Various sizes of jacket stripping tools may be provided to accommodate different sizes of the tubing. The second end is fitted to a rotational device such as a drill. The tool is actuated in a rotational manner which engages the blade with the sheathing of the corrugated tube. As the device rotates about the corrugated tube the blade works against the forward edge of the sheathing or jacket thereby removing the jacket in an axial or end circumferential manner as the corrugated tubing moves inward relative to the tool. It is preferred that the blade include at least one angled edge. The angle of the blade defines or cuts what may be described as a chamfered surface on the jacket as the tool rotates about the tube.

It is beneficial to the installer of the tube if the jacket at the point of cutting terminus is chamfered. This allows better fitment of any connector to the tubing. Because the tolerances are specific for removal of the jacket from the tubing, it is preferred that the inventive tool be configured specifically to remove the jacket from a targeted size of tubing. Therefore, a different tool would be utilized for each size of corrugated stainless steel tubing to be worked.

### BRIEF DESCRIPTION OF THE DRAWINGS

FIG. 1 is an exploded, perspective view of one embodiment of a jacket stripping tool of the instant invention having a jacket stripping blade mounted on a tubular body transverse to a cable receiving bore in the tubular body and extending into the cable receiving bore through a blade opening through the tool body.

FIG. 2 is a top plan view of the jacket stripping tool of FIG. 1.

FIG. 3 is a side plan view of the jacket stripping tool of FIG. 1.

FIG. 4 is a sectional view taken along line 4-4 of FIG. 2.

FIG. 5 is sectional view taken along line 5-5 of FIG. 2.

FIG. 6 is a perspective view of a jacket stripping blade of FIG. 1.

FIG. 7 is a bottom plan view of the jacket stripping blade.

FIG. 8 is a side view of the jacket stripping blade.

FIG. 9 is a top plan view of the jacket stripping tool showing a portion of a jacketed corrugated tube inserted into an open end of the jacket stripping tool, wherein the jacket stripping tool in FIG. 9 is slightly modified in relative dimensions as compared to the jacket stripping tool in FIG. 1.

FIG. 10 is and end view of the jacket stripping tool of FIG. 9.

FIG. 11 is a cross-sectional view taken along line 11-11 of FIG. 9 and showing a portion of the jacket being removed by a blade of the jacket stripping tool.

FIG. 12 is a cross-sectional view taken along line 12-12 of FIG. 11.

FIG. 13 is a cross-sectional view similar to FIG. 12 with the jacketed corrugated tube removed.

### DETAILED DESCRIPTION OF THE INVENTION

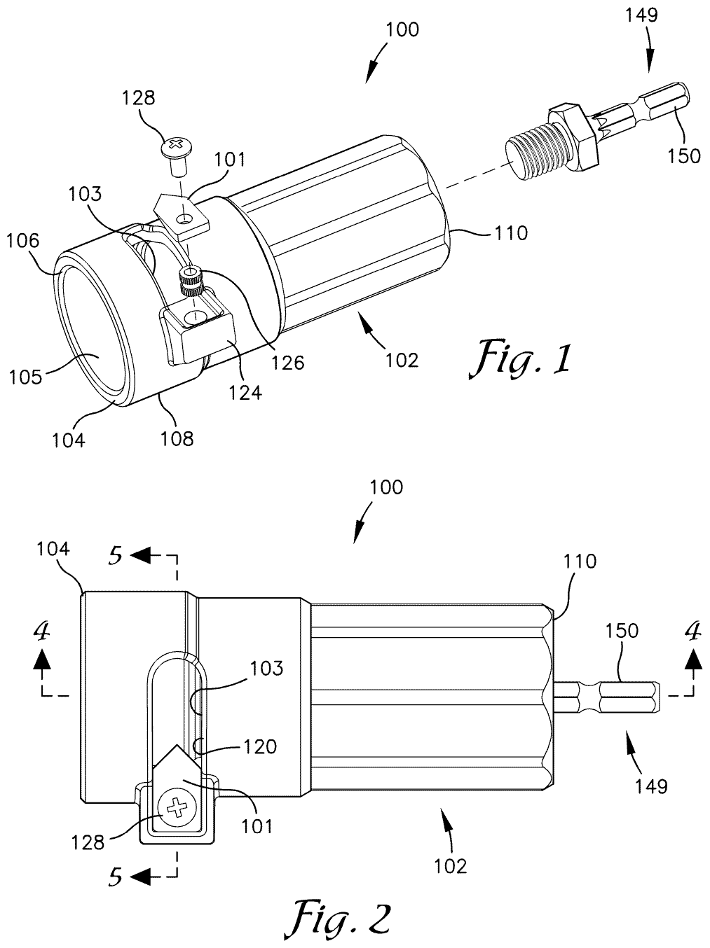

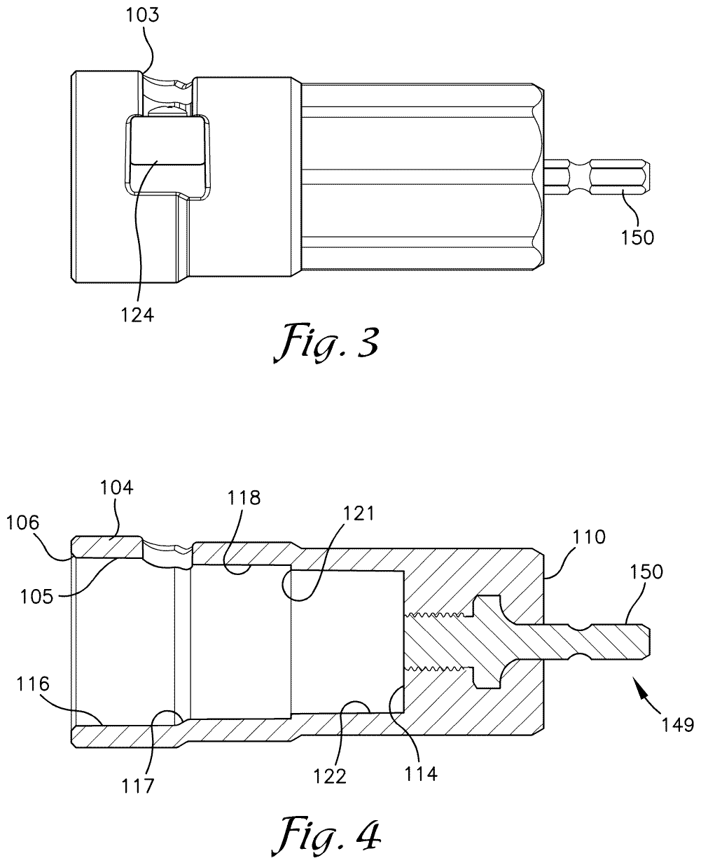

Referring now generally to the drawings, the instant invention relates to a tool 100 for removing the outer coating or jacket 12 from a corrugated, flexible and jacketed metal tube 14 to present a section of metal tubing 16 without the jacket 12. Referring to FIGS. 1-4, the tool 100 includes a blade 101 mounted on a tubular body 102 such that a cutting edge of the blade 101 extends through a blade opening 103 formed in a sidewall 104 of the tubular body 102 and into a tube receiving bore 105 extending longitudinally into the tubular body 102 from a first end opening 106 formed in a first end 108 of the tubular body 102. It is understood this tubular body 102 can be manufactured from rigid plastic, metal or other suitable materials. The first end opening 106 and bore 105 are sized to receive a jacketed corrugated tube (workpiece) 14 of a specific diameter. The tubular body 102 has a second or tool end 110 opposite the first end 108. As best shown in FIG. 4, a central jacketed tube receiving bore 105 extends axially into the tubular body 102 and substantially traverses the body 102 of the device from the first end opening 106 to a predetermined point or end wall 114 near the second end 110 wherein the second end is closed.

In the embodiment shown, and as best seen in FIG. 4, the bore 105 has different diameters along its length. Preferably, an initial, first or large bore section 116 originates at the first end opening 106 of the tubular body 102 and extends to a first shoulder 117 projecting radially inward or sloping inward from the initial bore section 116 to a second bore section 118 that is smaller in diameter than the initial bore section 116. The blade opening 103 is formed in and extends laterally through the body sidewall 104. In the embodiment shown, the blade opening 103 is formed through the body sidewall 104 closer to the first shoulder 117 than the first end 108 of the tubular body 102 with at least a centerline or long axis of the blade opening 103 extending forward from the first shoulder 117 toward the first end opening 106. As shown, a forward portion of the blade opening 103 extends through the portion of the body sidewall 104 surrounding the initial bore section 116 with a rear portion of the blade opening 103 extending through the portion of the body sidewall 104 surrounding the second bore section 118.

The second bore section 118 extends from the first shoulder 117, proximate a rear edge 120 of the blade opening 103 to a stop or second shoulder 121 projecting radially inward from the second bore section 118 to a third bore section 122 extending from the second shoulder 121 to the end wall 114. The diameter of the second bore section 118 is just slightly greater than the outer diameter of the corrugated metal tubing 16 without the jacket 12. The diameter of the third bore section 122 is smaller than the diameter of the second bore section 118 and smaller than the outer diameter of the corrugated metal tubing 16 so that the corrugated metal tubing 16 cannot advance past the second shoulder or stop 121 toward the second end 110 of the tubular body 102. Inclusion of the third bore section 122 reduces the material used for forming the tubular body 102, but is not required and the second stop 121 could be formed as an end wall of the bore 105 and second bore section 118 instead of as a shoulder.

The blade 103 is mounted on a blade mount or blade mounting platform 124 which is integrally formed with and projects outward from the tubular body 102 adjacent one end of the blade opening 103. The blade mounting platform 124 is specifically oriented to position the blade 101 to engage the terminus or exposed end of the jacket 12 at or near the end of the tubing 14. The blade opening 103 is preferably elongate with the long or longitudinal axis of the blade opening 103 extending substantially perpendicular or transverse to the longitudinal axis of the bore 112 which facilitates removed portions of the jacket 12 exiting through the blade opening 103 above the blade 101. Because the sizing of the bore 112, within the tool 100, is specific to the diameter of the tubing 14, the blade 101 can be fixed in a position where a cutting edge of the blade 103 engages the jacket 12 without engaging the underlying wall of the tubing 16. This prevents scoring or other damage to the metal tubing 16 of the workpiece. The blade mounting platform 124 is sized according to a preferred blade size and provides a substantially flat surface for mounting the blade 101. Further, the platform 124 has a fastening feature 126, such as a screw bore for the receipt of a fastening screw 128 to secure the blade 101 to the blade mounting platform 124.

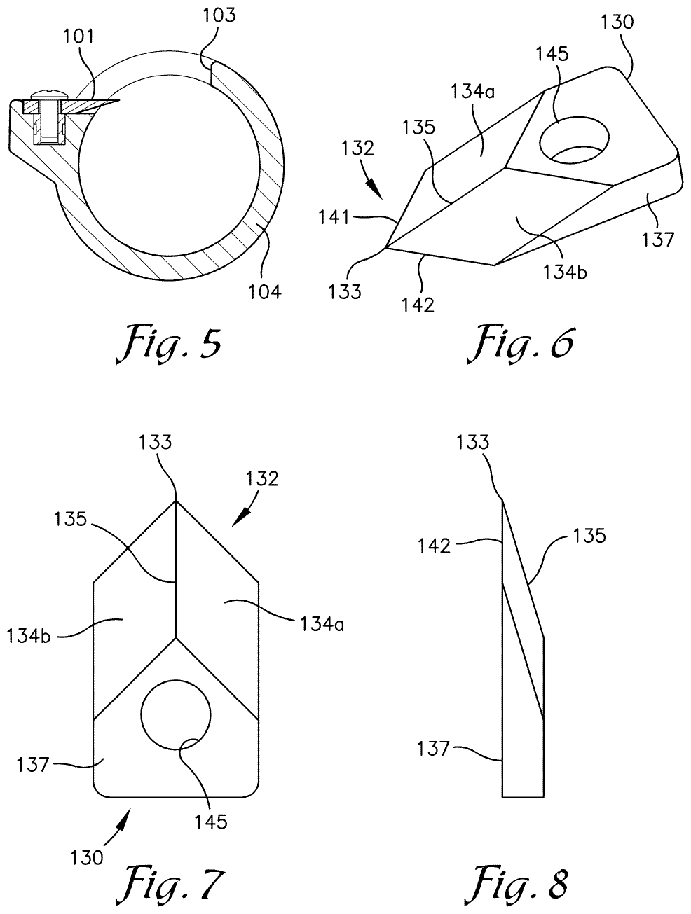

The cutting blade 101 can take different shapes or configurations. The preferred blade, best shown in FIGS. 6-8, has a fastening end 130 and a cutting end 132. The cutting end 132 terminates at a dagger point or cutting end tip 133 with substantially equal cutting bevels 134a and 134b provided on either side of a blade spine 135 running from the cutting end tip 133 rearward toward a base 137 of the cutting blade 101 proximate the fastening end 130. The bevels 134a and 134b form angled cutting edges 141 and 142 sloping rearward and outward from the cutting end tip 133 toward the fastening end 130. In the embodiment shown, the cutting edges 141 and 142 extend at an angle of approximately 45 degrees relative to the blade spine 135 and sides of the blade 101.

A fastener receiving hole 145 is formed in and through the base 137 of cutting blade 101. The base 137 is formed with two parallel faces sized to fit on the blade mounting platform 124 with the fastener receiving hole 145 in the blade base 137 aligned with the screw bore 126 formed therein so that the fastening screw may be inserted through hole 145 in the base 137 and threaded into the screw bore 126 in the blade base 137 to secure the blade 101 to blade mounting platform 124. The blade 101 is mounted on the platform 124 with the blade 101 oriented so that the forward end of the blade 101 extends through the blade opening 103 in the sidewall 104 of the tubular body 102 with at least a portion of a forward facing one of the cutting edges, cutting leading edge 141 in the embodiment shown, extending into and across a portion of the initial bore section 116.

In a preferred embodiment, and as generally shown the blade 122 is mounted on the blade mounting platform 124 with the bevels 134a and 134b oriented to face or extend inward or downward relative to the bore 112 of the tool 100. The bevels 134a and 134b may be described as being formed on the underside of the blade 122 and sloping downward and away from the cutting edges 141a and 141b toward the blade spine 135. The blade 101 is sized and positioned by blade mounting platform 124 so that the cutting edges 141a and 141b and the blade spine 135 are spaced further away from the center of the bore 105 and initial bore section 116 than the maximum radius of the corrugated metal tubing 16 when the jacketed tubing 14 is inserted into the initial bore section 116 in axial alignment therewith and a distal portion of the leading cutting edge 141a is spaced closer to the center of the initial bore section than the maximum radius of the jacket 12 on the jacketed tubing 14 when the jacketed tubing 14 is inserted into the initial bore section 116 in axial alignment therewith.

The inner diameter of the initial bore section 116 is sized to be the same size as or just slightly greater than the outer diameter of the jacket 12 on the jacketed tubing 14 so that the jacketed tubing 14 may be advance into the initial bore section 116. The material forming the jacket 12 of corrugated tubing with which the tool 100 is adapted for use is sufficiently compressible to allow the jacketed tubing 14 to be pushed into an initial bore section 116 with an inner diameter matching that of the outer diameter of the jacketed tubing 14.

If the jacketed tubing 14 is inserted through the inlet opening 106 of the initial bore section 116 at an angle such that the longitudinal axis of the jacketed tubing 14 is offset from the longitudinal axis of the initial bore section 116, the downward and inward sloping face of the bevel 134a extending downward and inward from the leading cutting edge 141a acts as a ramp or cam surface against which a peak of a leading corrugation of the corrugated tubing 16 will initially engage to force the orientation of the jacketed tubing 14 relative to the initial bore section 116 of the tubular body 102 back toward axial alignment to prevent the leading cutting edge 122a from engaging and cutting into the metal tubing 16 as it is advanced past the cutting edge 122a.

Generally, it is desirable to remove between approximately 1 inch to approximately 1 ½ inches of the jacketing material from the corrugated metal tubing 16 to provide a suitable connection or joint for attachment to a coupling end. The length of the tubular body 102 from the second shoulder or stop 121 to the tip 133 of the blade 101 corresponds to the length of jacket 12 to be removed.

A tool connector 149, as best seen in Figs. 1 and 4, may be provided at the second end 110 of the tubular body 102 for removably connecting to a driving device such as a hand drill or similar powered driver. As shown in FIGS. 1 and 4, the tool connector 149 may be threadingly connected to the tubular body 102 so that it is removable and it is understood that any variety of tool connectors could be used and differing tool connectors can be used such that any rotational tool could be used to rotate the stripping tool. The preferred tool connector 149 is formed as a hexagonal shank 150 for selective connection to a chuck of a drill or similar powered driver. It is also foreseeable that the tool connector 149 may be molded into the tool body 102 with the shank 150 projecting rearward therefrom. It is also foreseen that the tool connector could be formed as a hexagonal socket to receive a mating hexagonal head or tip of a driver.

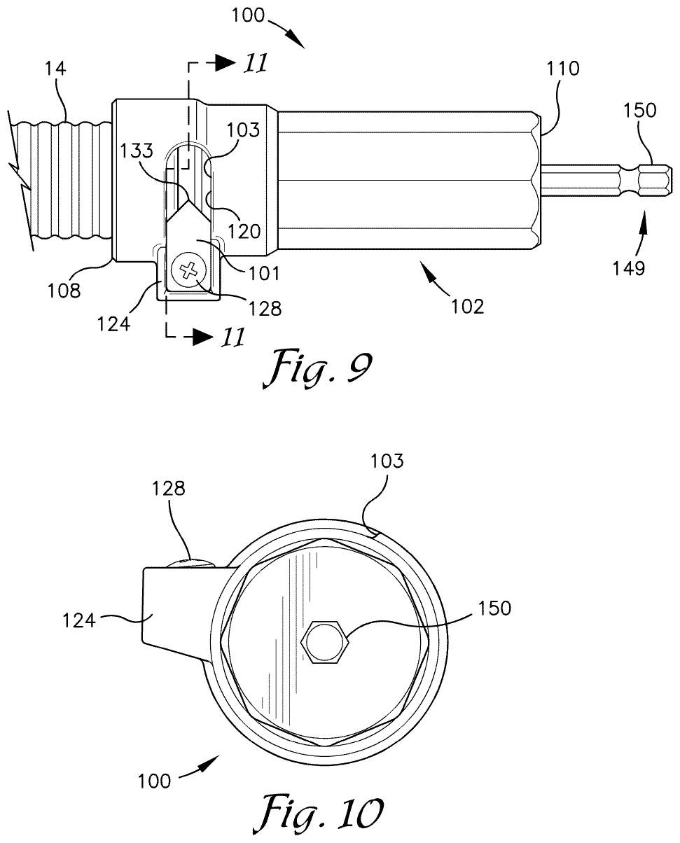

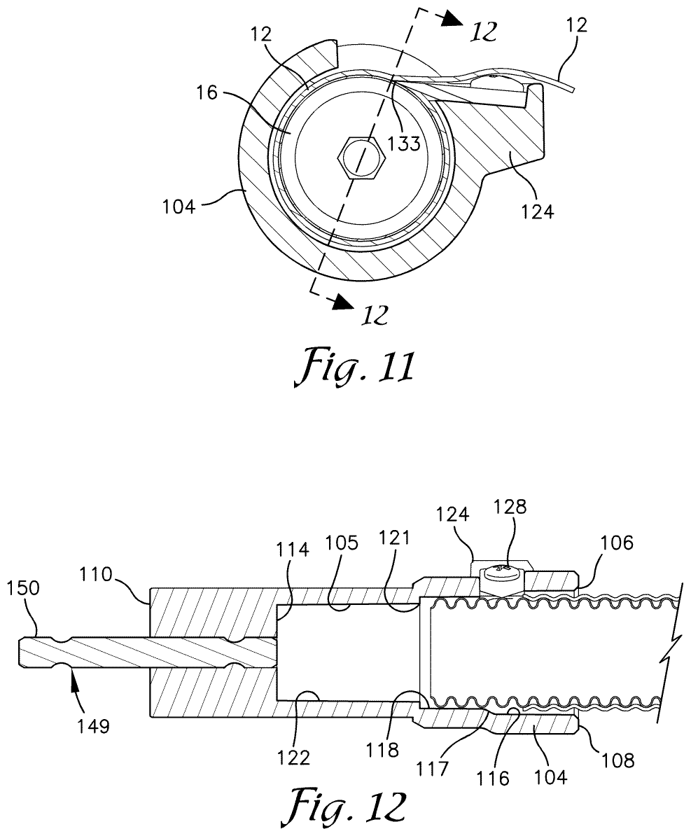

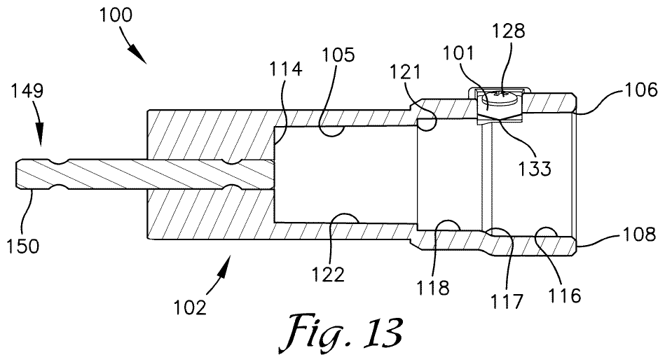

FIGS. 9-12 show a modified version of the jacket stripping tool 100 as shown in FIGS. 1-5 and with a length of jacketed tubing 14 inserted into the bore 105 formed therein. FIG. 12 shows the jacket 12 being removed from the corrugated metal tubing 16. FIG. 13 is a cross-sectional view of the jacket stripping tool 100 taken along its longitudinal axis and with the jacketed tubing 14 removed. Reference numbers used in FIGS. 9-13 correspond to the reference numbers used in FIGS. 1-8 for corresponding parts or components.

In operation, the tool connector 149 is secured in a chuck of a drill or similar rotational tool. The user inserts the end of the corrugated, jacketed tubing 14, from which the jacket 12 is to be removed, into the bore opening 106 at the first end 108 and advances the tubing until a leading edge of the jacket engages or abuts against the leading, cutting edge 141a of the blade 101. Upon actuation of the driving device, the tool connector 149 rotates the entire tool 100 and rotation of the tool 100 about the corrugated, jacketed tubing 14 advances the forwardly and outwardly sloping cutting edge 141a of the blade 101 further into the jacket 12 to form a spiral cut in the jacket 12 with the cut strip of jacket 12 advancing over the blade 101 and out blade opening 103. Once the jacket 12 is removed from the corrugated metal tubing 16, the outer diameter of the tubing 16 is small enough to advance into the second bore section 118 which maintains axial alignment of the corrugated tubing 16 within the bore 112. The forwardly sloping, leading cutting edge 141a of the blade 101 results in a chamfered edge being formed in the leading edge of the jacket 12 remaining on the jacketed tubing 14 which can facilitate installation by an installer in a coupling. Various sizes of the jacket stripping tool are provided to accommodate different sizes of the jacketed tubing 12.

What is claimed is:

1. A stripping tool for removal of a jacket from an end of a jacketed corrugated metal tube such that a length of corrugated metal tubing without the jacket is formed on the end of the jacketed corrugated metal tubing, the stripping tool comprising:
a body having a tube receiving bore extending into the body thorough an inlet opening at a first end of the body with a body sidewall surrounding the tube receiving bore, the tube receiving bore having an initial bore section having an inner diameter approximately equal to or slightly greater than an outer diameter of the jacketed corrugated metal tubing and a second bore section having an inner diameter smaller than the outer diameter of the jacketed corrugated metal tubing and slightly greater than an outer diameter of the corrugated metal tubing;
a first shoulder extending radially inward between the initial bore section and the second bore section and a stop formed at an inner end of the second bore section and extending radially inward relative to the sidewall of the body such that the corrugated metal tubing is not advanceable past the second stop,
a blade opening extending through the body sidewall along a portion of the initial bore section; and
a blade secured to the body and having a cutting edge extending through the blade opening and into the initial bore section of the body, the cutting edge spaced outward from a center of the tube receiving bore at a spacing greater than a maximum radius of the corrugated metal tubing inserted into the initial bore section and at least a portion of the cutting edge spaced outward from the center of the tube receiving bore at a spacing less than a maximum radius of the jacketed metal tubing inserted into the initial bore section in axial alignment therewith, wherein when the jacketed corrugated tubing is inserted into the initial bore section until the jacket engages the cutting edge of the blade, subsequent rotational movement of the body around the jacketed corrugated tubing cuts into the jacket but not the corrugated metal tubing with the jacket cut from the corrugated metal tubing advancing over the blade and out the blade opening.

2. The stripping tool of claim 1 further comprising a tool connector connected to and projecting outward from a second end of the body.

3. The stripping tool of claim 1 wherein the cutting edge comprises a first cutting edge and the blade includes a second cutting edge, the blade further includes a fastening end and a cutting end, the cutting end terminates at a cutting end tip with first and second cutting bevels provided on either side of a blade spine running from the cutting end tip toward the fastening end, the first and second bevels forming the first and second cutting edges, wherein the blade is mounted to the body such that the first and second cutting bevels slope inward and downward from the first and second cutting edges toward the blade spine.

4. The stripping tool of claim 3 wherein the blade spine extends transverse to a longitudinal axis of the tube receiving bore.

5. The stripping tool of claim 3 wherein a long axis of the blade opening and the blade spine extend transverse to a longitudinal axis of the tube receiving bore.

6. The stripping tool of claim 1 wherein the cutting edge extends in closely spaced relation outward from the first shoulder and toward the inlet opening along a longitudinal axis of the body.

7. A stripping tool for removal of a jacket from an end of a jacketed corrugated metal tube such that a length of corrugated metal tubing without the jacket is formed on the end of the jacketed corrugated metal tubing, the stripping tool comprising:
a tubular body having a tube receiving bore extending into the tubular body thorough an inlet opening at a first end of the tubular body with a tubular body sidewall surrounding the tube receiving bore, the tube receiving bore having an initial bore section having an inner diameter approximately equal to or slightly greater than an outer diameter of the jacketed corrugated metal tubing and a second bore section having an inner diameter smaller than the outer diameter of the jacketed corrugated metal tubing and slightly greater than an outer diameter of the corrugated metal tubing;
a first shoulder extending radially inward between the initial bore section and the second bore section and a stop formed at an inner end of the second bore section and extending radially inward relative to the sidewall of the tubular body such that the corrugated metal tubing is not advanceable past the second stop,
a blade opening extending through the tubular body sidewall along a portion of the initial bore section; and
a blade having a fastening end, a tip and a cutting edge extending from the tip toward the fastening end and a cutting bevel formed on an underside of the blade and sloping downward and away from the cutting edge toward a blade spine extending longitudinally along an underside of the blade from the tip to the fastening end, the fastening end secured to the tubular body adjacent the blade opening such that the cutting edge extends through the blade opening and into the initial bore section of the tubular body with the cutting bevel sloping from the cutting edge toward the blade spine and inward towards a center of the tube receiving bore, the cutting edge spaced outward from the center of the tube receiving bore at a spacing greater than a maximum radius of the corrugated metal tubing inserted into the initial bore section and at least a portion of the cutting edge is spaced outward from the center of the tube receiving bore at a spacing less than a maximum radius of the jacketed metal tubing inserted into the initial bore section in axial alignment therewith, wherein when the jacketed corrugated tubing is inserted into the initial bore section until the jacket engages the cutting edge of the blade, subsequent rotational movement of the tubular body around the jacketed corrugated tubing cuts into the jacket but not the corrugated metal tubing with the jacket cut from the corrugated metal tubing advancing over the blade and out the blade opening.

8. The stripping tool of claim 7 further comprising a tool connector connected to and projecting outward from a second end of the tubular body.

9. The stripping tool of claim 7 wherein the blade spine extends transverse to a longitudinal axis of the tube receiving bore.

10. The stripping tool of claim 7 wherein a long axis of the blade opening and the blade spine extend transverse to a longitudinal axis of the tube receiving bore.

11. The stripping tool of claim 7 wherein the cutting edge extends in closely spaced relation outward from the first shoulder and toward the inlet opening along a longitudinal axis of the tubular body.
